(19) United States
(12) Patent Application Publication
(10) Pub. No.: US 2003/0178888 A1
(43) Pub. Date: Sep. 25, 2003

(54) Decorative device

(76) Inventor: Wen-Chen Chang, Taichung (TW)

Correspondence Address: Wen-Chen Chang, 58, MA YUAN WEST ST., TAICHUNG, TW

(21) Appl. No.: 10/104,856

(22) Filed: Mar. 21, 2002

(51) Int. Cl. B60B 27/00

(52) U.S. Cl. 301/108.3

(57) ABSTRACT

A decorative device has a plurality of decorative panels. Each decorative panel has a plurality of patterned through holes and a pair of side flanges. The decorative device further has a decorative plate having an oblong hole and a plurality of lower hooks. The decorative device further has a decorative ring and a decorative disk engaging with the decorative ring. The decorative ring has a center hole and a plurality of posts. The decorative disk has a plurality of through apertures and a protruded collar having a center aperture. The protruded collar is inserted in the center hole of the decorative ring. Each post is inserted in the corresponding through apertures of the decorative disk.

### BACKGROUND OF THE INVENTION

The present invention relates to a decorative device. More particularly, the present invention relates to a decorative device for a suitcase.

A conventional suitcase does not have decorative plates, decorative rings, and decorative disks. It is difficult to assemble a decorative device and a conventional suitcase together.

### SUMMARY OF THE INVENTION

An object of the present invention is to provide a decorative device which is easily assembled.

Another object of the present invention is to provide a decorative device which has various colors on various parts of the decorative device to display various patterns.

Accordingly, a decorative device engages with an article. The article has a plurality of grooves. The decorative device comprises a plurality of protruded portions engaging with the corresponding groove of the article. Each protruded portion of the decorative device slant and extend outward. The decorative device further has a plurality of patterned through holes.

### BRIEF DESCRIPTION OF THE DRAWINGS

FIG. 1 is a perspective exploded view of a decorative device and a wheel of a preferred embodiment in accordance with the present invention;

FIG. 2 is a sectional assembly view of a decorative device and a wheel of a preferred embodiment in accordance with the present invention;

FIG. 3 is a perspective exploded view of a decorative device and a handle device of a preferred embodiment in accordance with the present invention;

FIG. 4 is a sectional assembly view of a decorative device and a handle device of a preferred embodiment in accordance with the present invention;

FIG. 5 is a perspective exploded view of a decorative device and a square tube of a preferred embodiment in accordance with the present invention;

FIG. 5A is a partially perspective enlarged view of a decorative panel of a preferred embodiment in accordance with the present invention;

FIG. 5B is a partially perspective enlarged view of a square tube of a preferred embodiment in accordance with the present invention;

FIG. 6 is an elevational assembly view of FIG. 5;

FIG. 6A is a partially sectional view of a positioning seat of a preferred embodiment in accordance with the present invention;

FIG. 7 is a sectional assembly view of a square tube and a plurality of decorative panels;

FIG. 8 is a sectional assembly view of a first round tube and a plurality of decorative panels; and

FIG. 9 is a sectional assembly view of a second round tube and a plurality of decorative panels.

### DETAILED DESCRIPTION OF THE INVENTION

A decorative device engages with an article. The article has a plurality of grooves. The decorative device comprises a plurality of protruded portions engaging with the corresponding groove of the article. Each protruded portion of the decorative device slant and extend outward. The decorative device further has a plurality of patterned through holes.

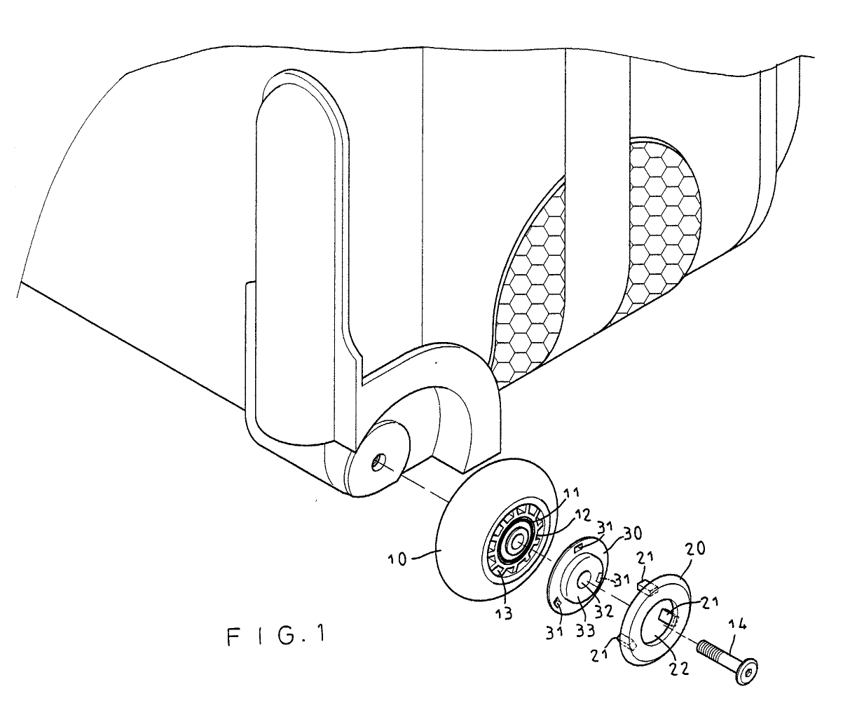

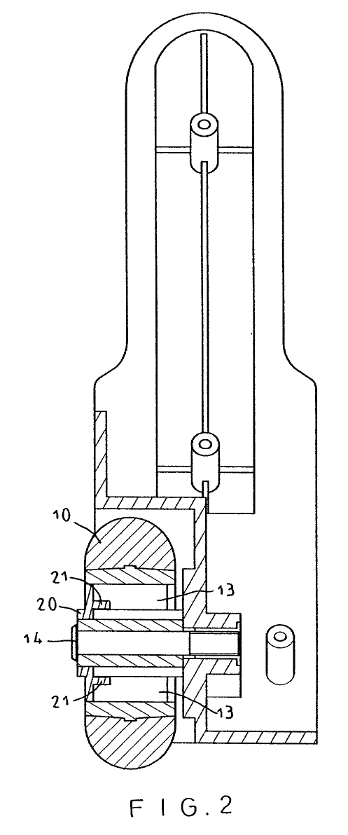

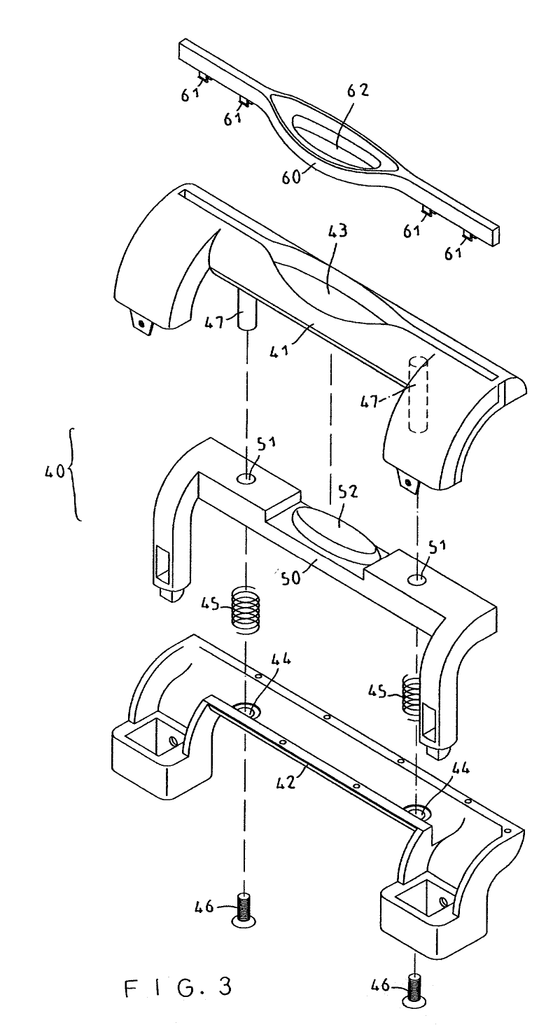

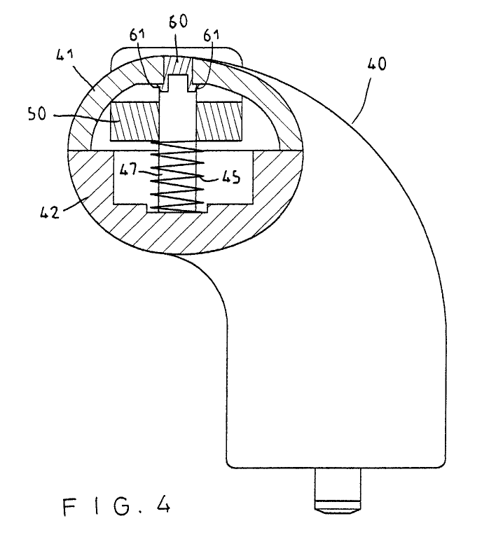

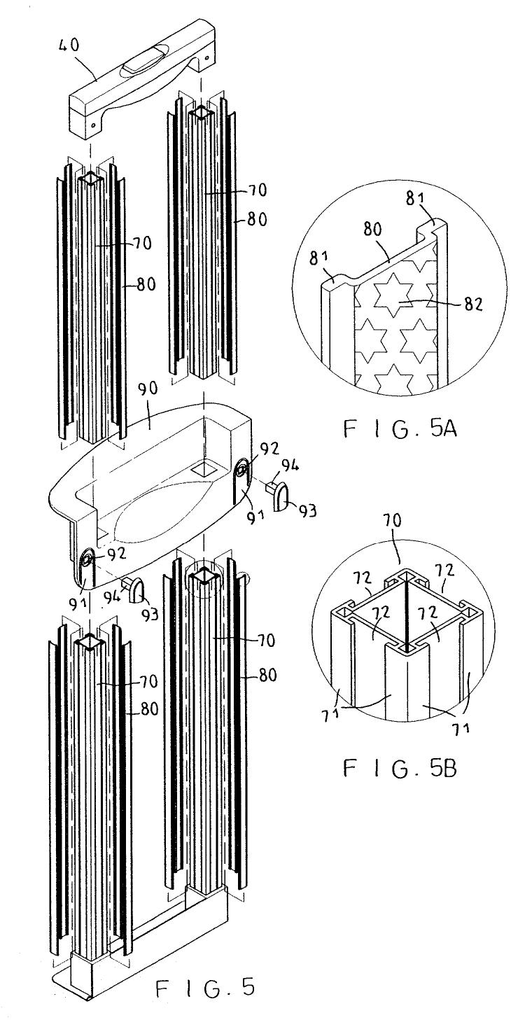

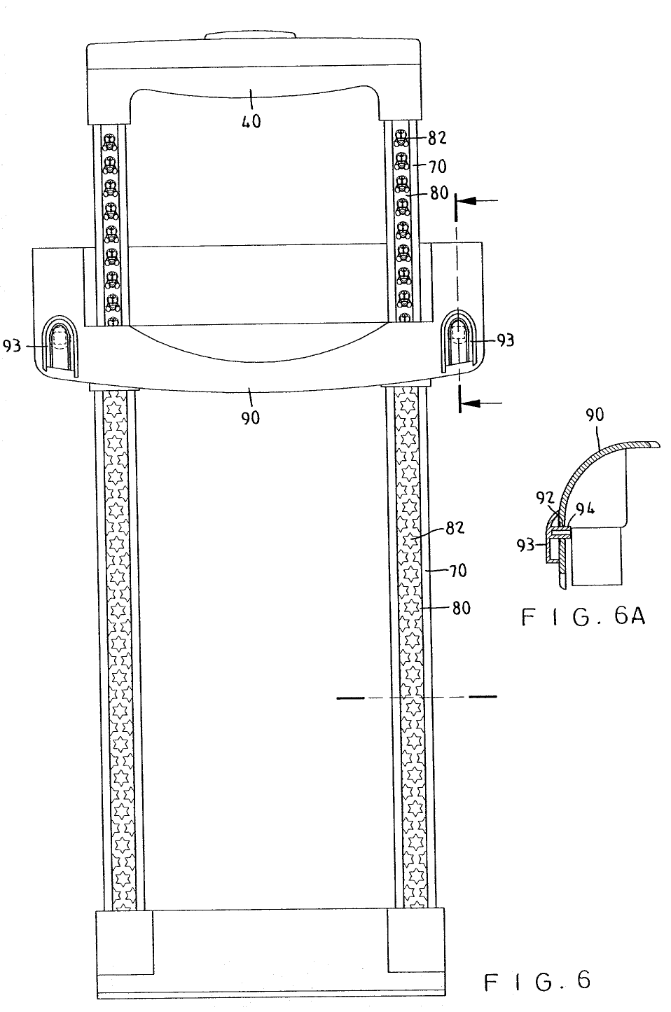

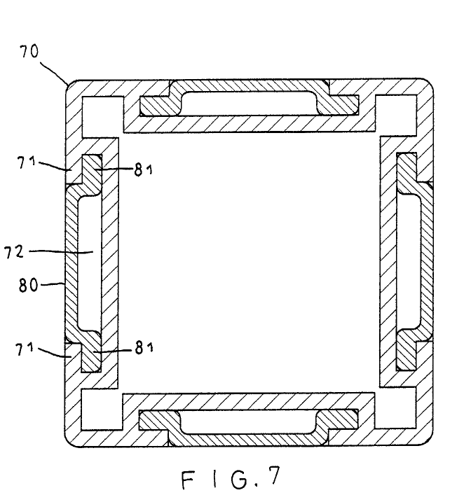

Referring to FIGS. 1 to 7, the decorative device comprises a plurality of decorative panels 80.

Each decorative panel 80 has a plurality of patterned through holes 82 and a pair of side flanges 81.

The decorative device further comprises a decorative plate 60 having an oblong hole 62 and a plurality of lower hooks 61.

The decorative device further comprises a decorative ring 20 and a decorative disk 30 engaging with the decorative ring 20.

The decorative ring 20 has a center hole 22 and a plurality of posts 21.

The decorative disk 30 has a plurality of through apertures 31 and a protruded collar 33 having a center aperture 32.

The protruded collar 33 is inserted in the center hole 22 of the decorative king 20.

Each post 21 is inserted in the corresponding through apertures 31 of the decorative disk 30.

The decorative device further comprises a decorative cover 93 having a pillar 94.

A suitcase 100 has at least a corner seat 101 having a threaded aperture 102.

A wheel 10 has a bearing 11 and a hub 12 having a plurality of radiated grooves 13.

The wheel 10 is disposed on the corner seat 101.

The decorative disk 30 is disposed on the wheel 10.

A threaded shaft 14 passes through the decorative disk 30, the wheel 10, and the corner seat 101.

A handle device 40 has a U-shaped upper casing 41, a U-shaped lower casing 42 engaging with the U-shaped upper casing 41, and a U-shaped pressing device 50 disposed between the U-shaped upper casing 41 and the U-shaped lower casing 42.

The U-shaped upper casing 41 has a slot 43 and two hollow columns 47.

The U-shaped lower casing 42 has a pair of round holes 44.

The U-shaped pressing device 50 has a button 52 and a pair of circular holes 51.

Two springs 45 are disposed between the U-shaped pressing device 50 and the U-shaped lower casing 42.

Each hollow column 47 passes through the corresponding circular hole 51 of the U-shaped pressing device 50, the corresponding spring 45, and the corresponding round hole 44 of the U-shaped lower casing 42.

Two screws 46 engage with the hollow columns 47.

The button 52 is inserted in the oblong hole 62 of the decorative plate 60.

The decorative plate 60 is inserted in the slot 43 of the U-shaped upper casing 41.

A positioning seat 90 has two recesses 91 and two oblong apertures 92.

The pillar 94 of the decorative cover 93 is inserted in the corresponding oblong apertures 92 of the positioning seat 90.

A pair of square tubes 70 are connected to the U-shaped lower casing 42 and the positioning seat 90.

Each square tube 70 has four corner frames 71 and four slide grooves 72.

Each slide groove 72 of the square tube 70 receives the side flanges 81 of the corresponding decorative panel 80.

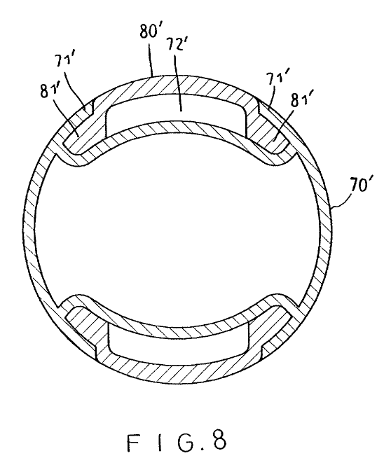

Referring to FIG. 8, a first round tube 70′ has two protruded frames 71′ and two slide grooves 72′.

An additional decorative panel 80′ has a pair of side flanges 81′.

Each slide groove 72′ of the first round tube 70′ receives the side flanges 81′ of the corresponding decorative panel 80′.

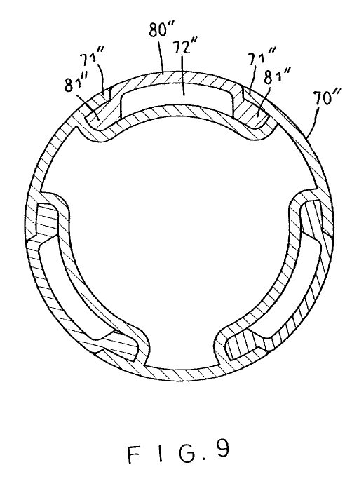

Referring to FIG. 9, a second round tube 70″ has three protruded frames 71″ and three slide grooves 72″.

A further decorative panel 80″ has a pair of side flanges 81″.

Each slide groove 72″ of the second round tube 70″ receives the side flanges 81″ of the corresponding decorative panel 80″.

The invention is not limited to the above embodiment but various modification thereof may be made. Further, various changes in form and detail may be made without departing from the scope of the invention.

I claim:

1. A decorative device engaging with an article, the article having a plurality of grooves, the decorative device comprising a plurality of protruded portions engaging with the corresponding groove of the article, characterized in that:
each said protruded portion of the decorative device slant and extend outward, and
the decorative device further has a plurality of patterned through holes.

2. The decorative device as claimed in claim 1, wherein the article is a wheel having a hub having a plurality of radiated grooves, the decorative device further comprises a decorative ring and a decorative disk engaging with the decorative ring, the decorative ring has a center hole and a plurality of posts, the decorative disk has a plurality of through apertures and a protruded collar having a center aperture, the protruded collar is inserted in the center hole of the decorative ring, each said post is inserted in the corresponding through apertures of the decorative disk, the decorative disk is disposed on the wheel, and a threaded shaft passes through the decorative disk and the wheel.

3. The decorative device as claimed in claim 1, wherein the article is a handle device having a U-shaped upper casing, a U-shaped lower casing engaging with the U-shaped upper casing, and a U-shaped pressing device disposed between the U-shaped upper casing and the U-shaped lower casing, the U-shaped upper casing has a slot, the decorative device further comprises a decorative plate having an oblong hole and a plurality of lower hooks, and the decorative plate is inserted in the slot of the U-shaped upper casing.

4. The decorative device as claimed in claim 1, wherein the article is a tube having four corner frames and four slide grooves, the decorative device further comprises at least a decorative panel, the decorative panel has a plurality of patterned through holes and a pair of side flanges, and each said slide groove of the tube receives the side flanges of the corresponding decorative panel.

5. The decorative device as claimed in claim 1, wherein the decorative device further comprises a decorative cover having a pillar.
